(19) United States
(12) Patent Application Publication
(10) Pub. No.: US 2018/0367597 A1
(43) Pub. Date: Dec. 20, 2018

(54) Method and System of Sharing a File

(71) Applicant: Ramakrishnan Kolli, Watervliet, NY (US)

(72) Inventor: Ramakrishnan Kolli, Watervliet, NY (US)

(21) Appl. No.: 15/624,293

(22) Filed: Jun. 15, 2017

(51) Int. Cl. H04L 29/08

(52) U.S. Cl. CPC H04L 67/06; G06F 17/30129; H04L 67/34; H04L 67/10

(57) ABSTRACT

The present disclosure relates to a method and system for sharing a file. The method comprises receiving one or more files, deriving a plurality of components from each of the one or more files, monitoring the plurality of components for determining an update in the plurality of components, retrieving a graph related to the one or more files, where the graph comprises a plurality of nodes and one or more paths, updating the one or more paths based on the monitoring of the plurality of components and determining one or more parameters associated with the updated one or more paths, where the one or more parameters are shared for embedding into the destination file. The disclosure provides an efficient file sharing method.

### TECHNICAL FIELD

The present disclosure relates to a method of file sharing. Particularly, but not exclusively, the present disclosure relates to a method and a system for sharing updates of a file with related files.

### BACKGROUND

File linking is a process of creating a link between two or more files. The existing file linking methodologies provide a static link between two or more files. For example, when two files are linked with each other, the linking is based on location of the two files, i.e., when location of either of the files are changed, the link between the two files are broken. Also, an update in a first file is not reflected in a second file. Thus, values of the second document dependent on values of the first document is not updated with update of the first document. Thus, the link between the first document and the second document is not dynamic. Further, when shared file is updated, entire updated file has to be shared instead of sharing only the updated information. As a result, the existing file linking methodologies do not provision dynamic linking of files.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method of sharing a file. The method describes that one or more files are received by an information processing system. Then, a plurality of components is derived from each of the one or more files. Thereafter, the plurality of components is monitored for determining an update in the plurality of components. Then, a graph related to the one or more files is retrieved, where the graph comprises a plurality of nodes, where a source node among the plurality of nodes correspond to a source file among the plurality of files and a destination node among the plurality of nodes correspond to a destination file. The graph further comprises one or more paths between at the source node and the destination node indicating a link between the plurality of components corresponding to the source file. The method further comprises updating, the one or more paths based on the monitoring of the plurality of components and determining one or more parameters associated with the updated one or more paths, where the one or more parameters are shared for embedding into the destination file.

In an embodiment, the present disclosure relates to an information processing system for sharing a file. The information processing system comprises a processor and a memory. The processor is configured to receive one or more files. The processor is further configured to derive a plurality of components from each of the one or more files. Thereafter, the plurality of components is monitored for determining an update in the plurality of components. Then, a graph related to the one or more files is retrieved, where the graph comprises a plurality of nodes, where a source node among the plurality of nodes correspond to a source file among the plurality of files and a destination node among the plurality of nodes correspond to a destination file. The graph further comprises one or more paths between at the source node and the destination node indicating a link between the plurality of components corresponding to the source file. Then, the processor updates the one or more paths based on the monitoring of the plurality of components and determines one or more parameters associated with the updated one or more paths, where the one or more parameters are shared for embedding into the destination file.

In an embodiment, the present disclosure relates to a non-transitory computer readable medium including instructions stored thereon that when processed by at least one processor cause a device to perform operations comprising receiving one or more files, deriving a plurality of components from each of the one or more files, monitoring the plurality of components for determining an update in the plurality of components, retrieving a graph related to the one or more files, where the graph comprises a plurality of nodes and one or more paths between at the source node and the destination node indicating a link between the plurality of components corresponding to the source file, updating the one or more paths based on the monitoring of the plurality of components and determining one or more parameters associated with the updated one or more paths, wherein the one or more parameters are shared for embedding into the destination file.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 is illustrative of an exemplary file sharing environment, in accordance with some embodiments of the present disclosure;

FIG. 2 is illustrative of internal architecture of an information processing system for sharing a file, in accordance with some embodiments of the present disclosure;

FIG. 3 shows an exemplary flowchart illustrating method steps for sharing a file in accordance with some embodiments of the present disclosure;

FIG. 4 shows a graph illustrating links between files, in accordance with some embodiments of the present disclosure; and

FIG. 5 shows a block diagram of a general-purpose computer system for sharing a file, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a method and a system for sharing files. An information processing system receives one or more files. The one or more files may be linked with each other. The linking between files may be represented by a graph. The graph comprises nodes indicating files corresponding to the one or more files. The link between the files may be represented as paths between the nodes. Further, when an update in made in a file, one or more parameters of corresponding paths may be updated to generate new paths. Thereafter, one or more parameters are determined from the new paths. Further, the one or more parameters are shared on a sharing platform.

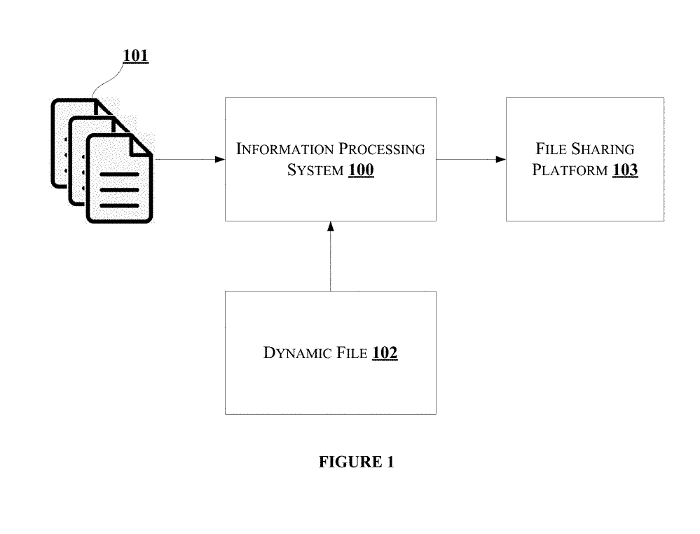

FIG. 1 shows an environment for sharing a file. The environment comprises an information processing system 100, one or more files 101, a dynamic file 102 and a file sharing platform 103. The information processing system 100 receives one or more files 101 for sharing. The one or more files 101 may be provided by a user device (not shown in figure). The one or more files 101 may be shared on a file sharing platform 103. The file sharing platform 103 may be accessed by any user with a valid permission. Further, only updates of the one or more files 101 may be shared on the file sharing platform 103. Here, users with valid access to the one or more files 101 and more specifically, users with valid access to corresponding updates of the one or more files 101 may access the updates. The one or more files 101 may be linked with a plurality of files. The link between a first file among the one or more files 101 and a second file among the plurality of files may be represented in the dynamic file 102. The dynamic file 102 comprises a graph representing a link between the first file and the second file. The graph comprises a plurality of nodes corresponding to the first file and the second file and one or more paths representing link between the first file and the second file. When information in at least one of the first file and the second file is updated, the one or more paths between corresponding nodes are updated as well. Further, one or more parameters associated with the updated one or more paths are determined. In an embodiment, the one or more parameters may be denoted as projections henceforth in the present disclosure. The projections are then shared in the file sharing platform 103.

In an embodiment, the projections may be shared on an exchange space or a market place, for example on a web page or the like.

In an embodiment, the file sharing platform 103 may include, but is not limited to a web portal, a data cloud, and the like.

In an embodiment, the information processing system 100 may store user permissions associated with each of the one or more files 101 and each update of the one or more files 101.

In an embodiment, the dynamic file 102 may be stored in a memory associated with the information processing system 100. In an embodiment, the dynamic file 102 may be accessed through one of a wired interface or a wireless interface. The wired interface may include, but is not limited to, Ethernet and the like. The wireless interface may include, but is not limited to, Wireless fidelity (Wi-Fi), Bluetooth, Infrared, and the like. The one or more files 101 may be received by the information processing system 100 through one of the wired interface or the wireless interface.

In an embodiment, the one or more files 101 and the plurality of files comprises at least one of a text file, an image file, a video file, a binary file, a data file, and program file.

In an embodiment, the user device may include, but is not limited to, a Personal Computer (PC), a Portable Digital Assistant (PDA), a laptop, a smartphone, or any other computing device.

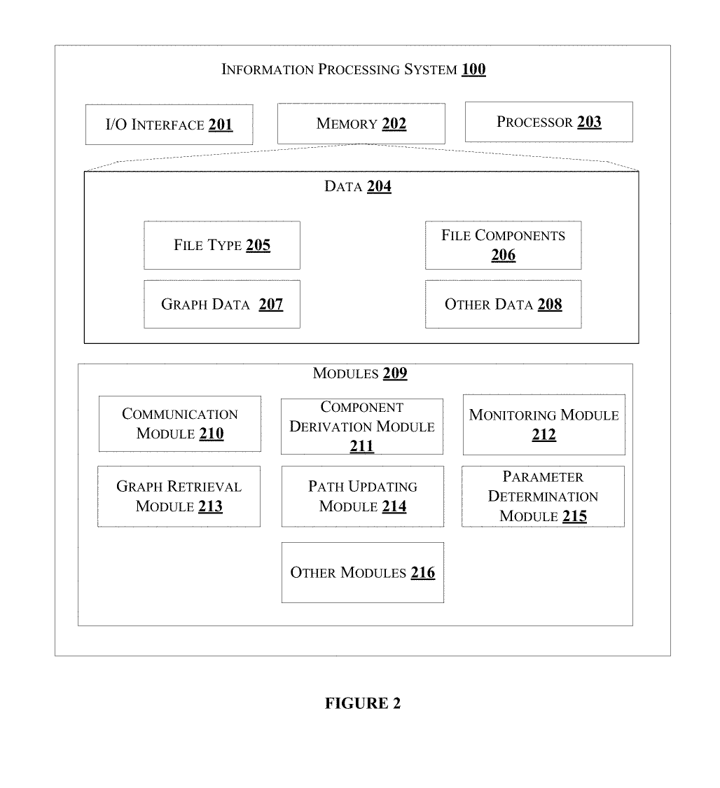

FIG. 2 illustrates internal architecture of the information processing system 100 in accordance with some embodiments of the present disclosure. The information processing system 100 may include at least one Central Processing Unit (“CPU” or “processor”) 203 and a memory 202 storing instructions executable by the at least one processor 203. The processor 203 may comprise at least one data processor for executing program components for executing user or system-generated requests. The memory 202 is communicatively coupled to the processor 203. The information processing system 100 further comprises an Input/Output (I/O) interface 201. The I/O interface 201 is coupled with the processor 203 through which an input signal or/and an output signal is communicated.

In an embodiment, data 204 may be stored within the memory 202. The data 204 may include, for example, file type 205, file components 206, graph data 207 and other data 208.

The file type indicates format of the one or more files 101 compatible with the information processing system 100. In an embodiment, the file type 205 may include, but is not limited to, at least one of a text file, an image file, a video file, a binary file, a data file, and program file.

The file components may be extracts of the file. In an embodiment, the file components 206 may include, but is not limited to, a text, a color, a pixel and an image frame.

In an embodiment, the graph data 207 may include, but is not limited to, a plurality of nodes corresponding to the one or more files 101, one or more paths between the plurality of nodes indicating link between files.

In an embodiment, the other data 208 may include, but is not limited to, user permissions, number of files linked to a file being updated, etc.

In an embodiment, the data 204 in the memory 202 is processed by modules 209 of the information processing system 100. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The modules 209 when configured with the functionality defined in the present disclosure will result in a novel hardware.

In one implementation, the modules 209 may include, for example, a communication module 210, a component derivation module 211, a monitoring module 212, a graph retrieval module 213, a path updating module 214, a parameter determination module 215 and other modules 216. It will be appreciated that such aforementioned modules 209 may be represented as a single module or a combination of different modules.

In an embodiment, the communication module 210 receives the one or more files 101. The one or more files 101 may be received from the user device. The communication module 210 may receive the one or more files 101 through one of the wired interface and the wireless interface.

In an embodiment, the component generation module 211 generates a plurality of components for each of the one or more files 101. Here, componentization is performed to detect updates or changes in each of the one or more files 101. The plurality of components may comprise at least one of a text, a color, a pixel, and an image frame. The plurality of components may be generated using existing methods.

In an embodiment, the monitoring module 212 monitors the plurality of components. Here, an update of a component is monitored. The update may be in form of an addition of component, a deletion of a component or modification of a component.

In an embodiment, the graph retrieval module 212 retrieves a graph from the dynamic file 102. The graph comprises a plurality of nodes, each node representing a file from the one or more files 101. Further, the graph comprises one or more paths between at least two nodes among the plurality of nodes. The path indicates a link between the corresponding one or more files 101. Here, the link is a measure of how two files are related to each other. In an embodiment, one file may be related to a plurality of files. The graph is a mathematical representation of relation between each of the one or more files 101 and the plurality of files. In an embodiment, the one or more paths may be represented by equations. In an embodiment, the equations may have one or more input variables and one or more output variables. The one or more input variables and the one or more output variables may constitute a graph with one or more paths between at least two nodes among the plurality of nodes.

In an embodiment, the path updating module 214 receives monitored data from the monitoring module 212. Based on updates made in at least one of the one or more files 101, the path updating module 214 updates corresponding paths in the graph. Updating the paths comprises altering values of variables in the equations.

In an embodiment, the parameter determination module 215 determines one or more parameters of the updated one or more paths. The one or more parameters are the projections of the updated paths. The projections are determined using values of the updated equations. The projections are may be in a format that may be shared with users associated with the one or more files 101. Then, the projections are shared with the users on the file sharing platform 103. For example, let us consider a path denoted by an equation 2+3=5. Here, let a first path be denoted by the value 2 and a second path be denoted by the value 3. Let us assume that the first path is updated, and the updated path be represented by the value 4. Hence, the equation may be updated as well, represented by 4+3=7. Thus, an update in the one or more files 101 shall be reflected by an update in the equation of corresponding paths. In an embodiment, the equations may be represented by logical variables, for example, y+ax=c. Also, the one or more paths may represent colors to portray an update. In an embodiment, any type of equation or representation may be provided to indicate the one or more paths and an update in the one or more paths.

In an embodiment, the other modules 216 may include a notification module, a user authentication module and a cost estimation module. The notification module may notify a user when a file associated with the user is updated. In an embodiment, the user authentication module may prompt the user with credentials for accessing one or more files 101 associated with the user. In an embodiment, the cost estimation module may estimate a cost for sharing relevant information regarding an update or any information of the one or more files 101 with respective users. Here, the cost estimation module may further restrict access to the user until necessary fee is paid by the user to access the one or more files 101.

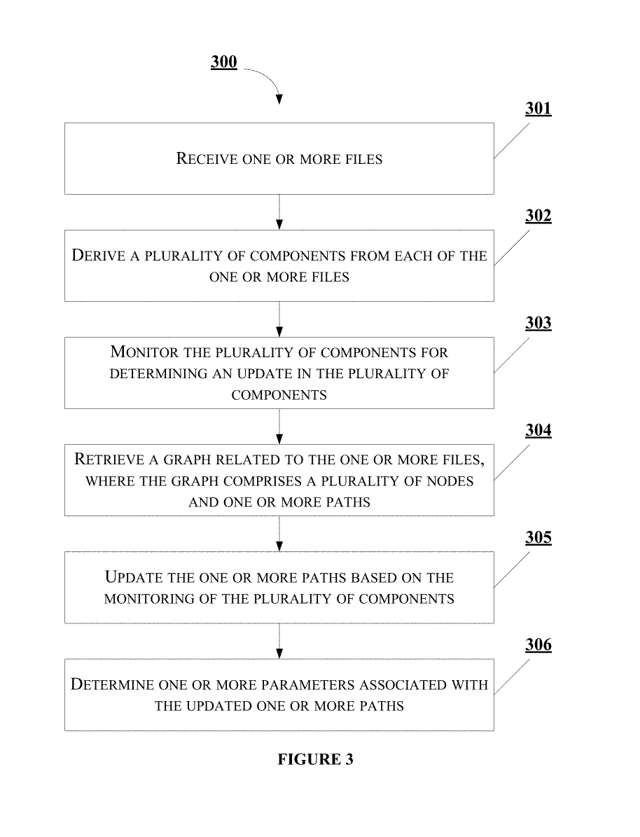

FIG. 3 shows a flow chart illustrating a method for sharing a file, in accordance with some embodiments of the present disclosure.

As illustrated in FIG. 3, the method 300 may comprise one or more steps sharing a file, in accordance with some embodiments of the present disclosure. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

Consider a first user intending to share predefined portion of information from the one or more files 101. The following steps describe a methodology for sharing the predefined portion of information from the one or more files 101.

At step 301, the communication module 210 receives the one or more files 101 from the user device. The user device may be associated with the first user.

At step 302, the component derivation module 211 may derive the plurality of components from each of the one or more files 101. Here, the plurality of components may be encoded in a single file as facet. Here, facet is a representation of the plurality of components grouped in a predefined manner. Unlike file types, which is based on type of storing files, the facet is group of components based on relation between the components. In a scenario, the facet of a predefined type may be shared with users.

At step 303, the monitoring module 212 monitors the plurality of components. The monitoring module 212 checks whether any of the plurality of components are updated. When a component among the plurality of components is updated, the monitoring module 212 notifies concerned user using the notification module. Here, the update may be at least one of addition, deletion and modification of information in the one or more files 101 corresponding to the updated component.

At step 304, the graph retrieval module 213 retrieves the graph from the dynamic file 102. In an embodiment, the dynamic file 102 may be stored in the information processing system 100. Alternatively, the dynamic file 102 may be stored in a database (not shown in figure) associated with the information processing system 100. The graph comprises a plurality of nodes and one or more paths connecting the at least two nodes among the plurality of nodes. In an embodiment, a node may represent a file. In another embodiment, the node may comprise sub nodes. Here, the node may be a basic storage unit in the information processing system 100. The nodes are the unit present in every file type like images, audio, video and documents. The one or more paths define a link between the at least two nodes. Here, the path may be defined by equations. The one or more paths may be built based on the plurality of components. When a file is updated, the plurality of components are updated. Thus, one or more paths corresponding to the updated file are updated. The update of the one or more paths may be performed by updating values of the equation. Thus, the one or more new paths or one or more updated paths are indicative of update in the corresponding files. In an embodiment, the graph is a directed graph. In an embodiment, the graph may be an acyclic graph.

At step 305, the path updating module 214 receives monitoring data from the monitoring module 213. The path updating module 214 particularly receives information about updated plurality of components. Then, the path updating module 214 updates existing paths connecting a first node corresponding to the updated file with one or more nodes associated with the first node.

At step 306, the parameter determination module 215 determines one or more parameters of the updated one or more paths. The one or more parameters are projections of the updates of the one or more files 101. Then, the projections are shared with users with valid permission for accessing the one or more files 101.

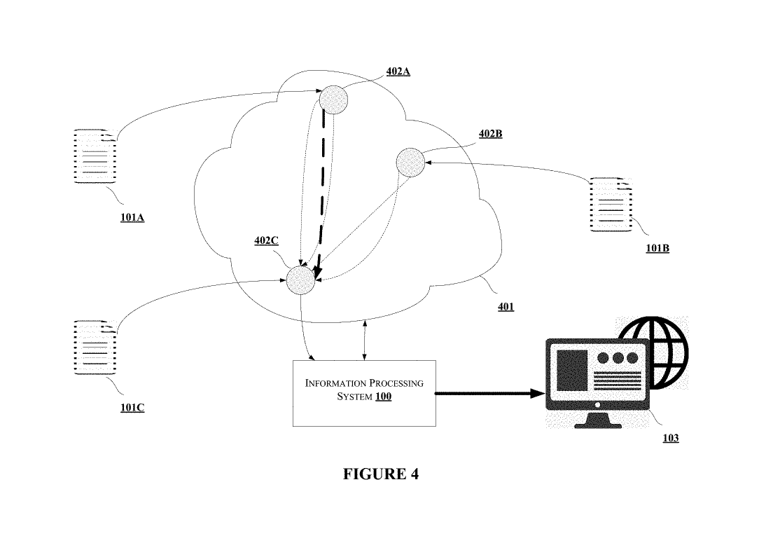

FIG. 4 illustrates a scenario of method steps of the present disclosure. Consider three files 101A, 101B and 101C. Consider a graph 401 indicating a link between the three files. Let the graph 401 comprise three nodes 402A, 402B and 402C corresponding to the three files 101A, 101B and 101C respectively. Let the file 402C be linked with the files 402A and 402B by dotted (not bold) lines as shown in the figure. Here, let the file 402C be shared with a user having permission to access the file. Now let us assume, the file 101A is updated. Here, instead of sharing the entire updated file with the user, only the updated information may be shared with the user as projection. When the file 101A is updated, corresponding updated plurality of components are derived. Further, the path updating module 214 updates the paths between the node 402A and the node 402C. The updated path is represented by dotted (bold) line in the figure. As the graph is a directed graph, the updated path indicates that the file 101A is updated. Further, the projections of the updated graph are determined. The projections are determined using values of equations of the paths. Lastly, the projections are shared with users. The projections are indicated by bold line from the information processing system 100 to the file sharing platform 103.

In an embodiment, the projections may be shared on a market place for a return of service or a predefined price. In an embodiment, a super user may monitor the market place and may administer the sharing of the projections.

An example scenario is described below which may be an application of the present disclosure.

An employee of a company may require important information of the company. The employee may prepare a dynamic file that aggregates information in cellular (spreadsheet) facet or documents, text facet, describing each part of the company and reports facets showing all graphs etc. The dynamic file may contain projections from, for example, accounting department, engineering department, human resources department etc. The employee may be able to either see data, report charts, a description of department wise or entire company activities. Further, the data may be either day by day or month by month or any other updateable granularity that is compatible by the information processing system 100. The dynamic file may have data based on day by day information or month by month or a predefined time period. Further, the projections may be shared with other employees having permission to access respective data.

In an embodiment, a plurality of files may be linearly linked. For example, consider four files, a first file, a second file, a third file and a fourth file. Let the fourth file be linked with the third file, the third file be linked with the second file, and the second file be linked with the first file. When there is an update in the first file, the second file is updated based on changes in the first file, the third file is updated based on updates in the second file and the fourth file is updated based on updates in the third file. Further, a user of the first file may have access only to the first file, a user of the second file may have access to the second file and the updates of the second file, a user of the third file may have access to the third file and the updates of the third file, a user of the fourth file may have access to the fourth file and the updates of the fourth file.

In an embodiment, loop possibilities in the graph are detected and eliminated before approving using of a shared projection by a user. For example, consider a first user shares a projection of a first file with a second user associated with a second file and a third user associated with a third file. Here, the projections are shared such that the second user shall be able to access contents associated with the second file and the third user shall be able to access contents associated with the third file. Thus, the projections of the first file may have multiple loops associated with multiple files. The information processing system 100 detects such loops and eliminates loops that are not authorized by a user.

In an embodiment, a node related to a facet can be embedded and processed in a different facet. In an embodiment, a facet may be universally available, and need not be shared by a user to another user. When the plurality of components are generated, facets are created and are available the exchange space or the market place.

### Computer System

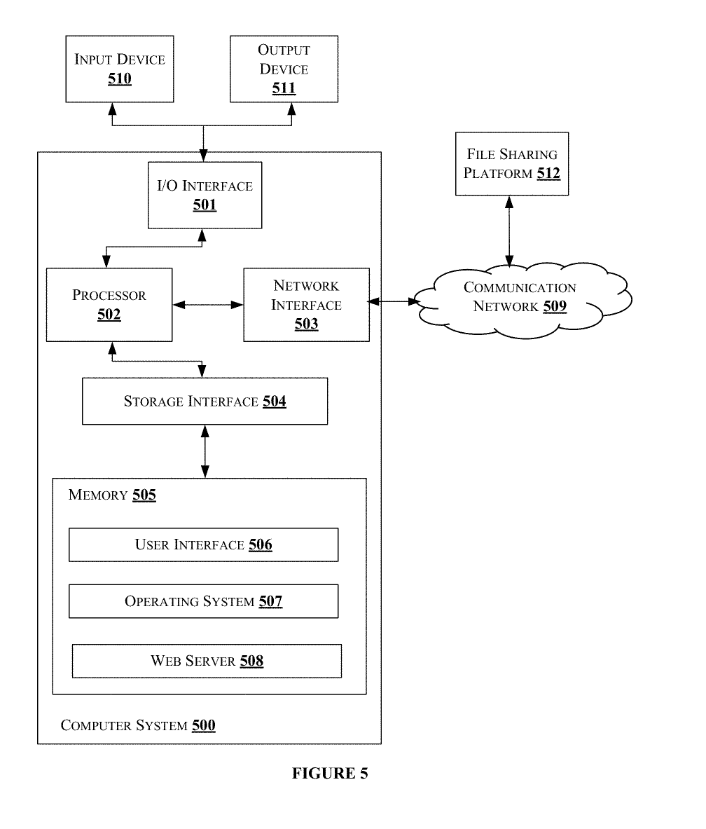

FIG. 5 illustrates a block diagram of an exemplary computer system 500 for implementing embodiments consistent with the present disclosure. In an embodiment, the computer system 500 is used to implement the method for sharing a file. The computer system 500 may comprise a central processing unit (“CPU” or “processor”) 502. The processor 502 may comprise at least one data processor for executing program components for sharing a file. The processor 502 may include specialized processing units such as integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device 510 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 511 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 is connected to the service operator through a communication network 509. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network 509 may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface 503 and the communication network 509, the computer system 500 may communicate with the one or more service operators.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507, web server 508 etc. In some embodiments, computer system 500 may store user/application data 506, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, 10 etc.), Apple iOS, Google Android, Blackberry OS, or the like.

In some embodiments, the computer system 500 may implement a web browser 508 stored program component. The web browser 508 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

In an embodiment, the computer system 500 may share data with the file sharing platform 512.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

In an embodiment, the method and system of the present disclosure helps share only required data with users.

In an embodiment, the present disclosure discloses a method to reduce complexity in sharing files by determining projections and sharing the same with the users.

In an embodiment, the present disclosure discloses a method of connectivity between files by making use of graphs for linking the files.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference number | Description |
|---|---|
| 100 | Information processing system |
| 101 | Files |
| 102 | Dynamic file |
| 103 | File sharing platform |
| 201 | I/O interface |
| 202 | Memory |
| 203 | Processor |
| 204 | Data |
| 205 | File type |
| 206 | File components |
| 207 | Graph data |
| 208 | Other data |
| 209 | Modules |
| 210 | Communication module |
| 211 | Component generation module |
| 212 | Monitoring module |
| 213 | Graph retrieval module |
| 214 | Path updating module |
| 215 | Parameter determination module |
| 216 | Other modules |
| 401 | Graph |
| 402 | Nodes |
| 500 | Computer system |
| 501 | I/O interface |
| 502 | Processor |
| 503 | Network interface |
| 504 | Storage interface |
| 505 | Memory |
| 506 | User interface |
| 507 | Operating system |
| 508 | Web server |
| 509 | Communication network |
| 510 | Input devices |
| 511 | Output devices |
| 512 | File sharing platform |

I claim:

1. A method of sharing a file, comprising:
receiving, by an information processing system, one or more files;
deriving, by the information processing system, a plurality of components from each of the one or more files;
monitoring, by the information processing system, the plurality of components for determining an update in the plurality of components;
retrieving, by the information processing system, a graph related to the one or more files, wherein the graph comprises:
a plurality of nodes, wherein a source node among the plurality of nodes correspond to a source file among the plurality of files and a destination node among the plurality of nodes correspond to a destination file, and
one or more paths between at the source node and the destination node indicating a link between the plurality of components corresponding to the source file;
updating, by the information processing system, the one or more paths based on the monitoring of the plurality of components; and
determining, by the information processing system, one or more parameters associated with the updated one or more paths, wherein the one or more parameters are shared for embedding into the destination file.

2. The method of claim 1, wherein the one or more files comprises at least one of a text file, an image file, a video file, a binary file, an executable file, an audio file, a data file, and program file.

3. The method of claim 1, wherein the plurality of components comprises at least one of text, colors, pixels, and image frames.

4. The method of claim 1, wherein the one or more paths are indicated by equations.

5. The method of claim 1, wherein the graph is a directed graph.

6. The method of claim 1, wherein the destination file is associated with user permission.

7. The method of claim 1, wherein the destination file is used by a user.

8. The method of claim 1, wherein the one or more parameters comprises at least one of values associated with the plurality of updated components, and the updated plurality of components.

9. An information processing system for sharing a file, comprising:
a processor; and
a memory, communicatively coupled to the processor, storing processor executable instructions, which, on execution causes the processor to:
receive one or more files;
derive a plurality of components from each of the one or more files;
monitor the plurality of components for determining an update in the plurality of components;
retrieve a graph related to the one or more files, wherein the graph comprises:
a plurality of nodes, wherein a source node among the plurality of nodes correspond to a source file among the plurality of files and a destination node among the plurality of nodes correspond to a destination file, and
one or more paths between at the source node and the destination node indicating a link between the plurality of components corresponding to the source file;
update the one or more paths based on the monitoring of the plurality of components; and
determine one or more parameters associated with the updated one or more paths, wherein the one or more parameters are shared for embedding into the destination file.

10. The information processing system of claim 9, wherein the one or more files comprises at least one of a text file, an image file, a video file, a binary file, a data file, and program file.

11. The information processing system of claim 9, wherein the plurality of components comprises at least one of text, colors, pixels, and image frames.

12. The information processing system of claim 9, wherein the one or more paths are indicated by equations.

13. The information processing system of claim 9, wherein the graph is a directed graph.

14. The information processing system of claim 9, wherein the destination file is associated with a unique user permission.

15. The information processing system of claim 9, wherein the destination file is used by a user.

16. The information processing system of claim 9, wherein the one or more parameters comprises at least one of values associated with the plurality of updated components, and the updated plurality of components.

17. A non-transitory computer readable medium including instructions stored thereon that when processed by at least one processor cause a device to perform operations comprising:
receiving one or more files;
deriving a plurality of components from each of the one or more files;
monitoring the plurality of components for determining an update in the plurality of components;
retrieving a graph related to the one or more files, wherein the graph comprises:
a plurality of nodes, wherein a source node among the plurality of nodes correspond to a source file among the plurality of files and a destination node among the plurality of nodes correspond to a destination file, and
one or more paths between at the source node and the destination node indicating a link between the plurality of components corresponding to the source file;
updating the one or more paths based on the monitoring of the plurality of components; and
determining one or more parameters associated with the updated one or more paths, wherein the one or more parameters are shared for embedding into the destination file.

18. The medium of claim 17, wherein the one or more files comprises at least one of a text file, an image file, an executable file, an audio file, a video file, a binary file, a data file, and program file.

19. The medium of claim 17, wherein the plurality of components comprises at least one of text, colors, pixels, and image frames.

20. The medium of claim 17, wherein the one or more paths are indicated by equations.

21. The medium of claim 17, wherein the graph is a directed graph.

22. The medium of claim 17, wherein the destination file is associated with a unique user permission.

23. The medium of claim 17, wherein the destination file is used by a user.

24. The medium of claim 17, wherein the one or more parameters comprises at least one of values associated with the plurality of updated components, and the updated plurality of components.
